(19) United States
(12) Patent Application Publication
(10) Pub. No.: US 2006/0026137 A1
(43) Pub. Date: Feb. 2, 2006

(54) Method and apparatus for integrating a list of selected data entries into a spreadsheet

(76) Inventors: Juergen Sattler, Wiesloch (DE); Hilmar Demant, Karlsdorf (DE); Joachim Gaffga, Wiesloch (DE); Tobias Haug, Heidelberg (DE)

Correspondence Address: KENYON & KENYON, 1500 K STREET NW, SUITE 700, WASHINGTON, DC, 20005, US

(21) Appl. No.: 11/026,051

(22) Filed: Jan. 3, 2005

Related U.S. Application Data
(60) Provisional application No. 60/586,233, filed on Jul. 9, 2004.
(60) Provisional application No. 60/586,234, filed on Jul. 9, 2004.
(60) Provisional application No. 60/620,682, filed on Oct. 22, 2004.

(51) Int. Cl. G06F 17/30

(52) U.S. Cl. 707/3

(57) ABSTRACT

A method and apparatus for integrating a list of selected data entries into a spreadsheet is provided. In some embodiments, data entries may be selected from a data set stored on a computer system using a first computer program to obtain a group of selected data entries. If a user of the first computer program has made a request to export the group of selected data entries from the first computer program to a spreadsheet program, the group of selected data entries may be formatted into a spreadsheet data file that is in a format recognized by the spreadsheet program and the spreadsheet program may execute with the spreadsheet data file. If it is determined that a request was received from the spreadsheet program for refreshed data, a current data value for at least one entry in the data set may be written into a corresponding entry in the spreadsheet data file.

### BACKGROUND

The present invention relates to the maintenance of data sets and the manipulation of data using spreadsheet programs. Such a data set may be stored, for example, in a database. It is common for users of computer systems to select a list or table of data at a user-interface of the computer system. For example, the user of a customer relationship management (“CRM”) system may input information that identifies one or more transaction records stored by the CRM system. When it receives a request, the system may select a data object or a list of data entries from a stored data set and may display the selected data to the user as a list, table, or any type of report.

Computer users frequently employ spreadsheet software application programs, such as Microsoft Excel®, Lotus 1-2-3®, etc., to operate upon data values. Spreadsheet programs let users create and manipulate electronic spreadsheets, which may contain a table of values arranged in rows and columns and having a predefined relationship to the other values. Known systems do not allow users to integrate a list of entries selected from a data set into a spreadsheet program. For example, the present inventors perceived a need in the art for, among other things, a mechanism to export a list of selected data entries to a spreadsheet program that allows a user to later refresh the data being operated on by the spreadsheet program. As other examples, the present inventors perceived a need in the art for a mechanism to allow for the reuse of earlier-defined spreadsheet layout templates when exporting data into a spreadsheet, and/or a mechanism to upload data from the spreadsheet program back into a database.

### BRIEF DESCRIPTION OF THE DRAWINGS

FIG. 1 is a simplified block diagram that illustrates a computer system in which a group of selected entries may be integrated into a spreadsheet program according to an embodiment of the present invention.

FIG. 2 is a simplified block diagram that illustrates a user-interface for a program that selects a list of data entries and a user-interface for a spreadsheet program according to an embodiment of the present invention.

FIG. 3 is a simplified block diagram that illustrates the integration between entries in a data set and a spreadsheet data file according to an embodiment of the present invention.

FIG. 4 is a simplified flow diagram that illustrates a method of integrating a group of data entries into a spreadsheet program according to an embodiment of the present invention.

FIG. 5 is a simplified flow diagram that illustrates a method of creating a spreadsheet-formatted data file based on a group of data entries according to an embodiment of the present invention.

FIG. 6 is a simplified block diagram that illustrates a more detailed view of a user-interface for a program that selects a group of data entries according to an embodiment of the present invention.

FIG. 7 is a simplified block diagram that illustrates program control flow for the integration of selected data entries into a spreadsheet according to an embodiment of the present invention.

### DETAILED DESCRIPTION

The present invention provides methods and apparatus for integrating data entries selected from a data set into a spreadsheet. In some embodiments, the system may provide an option (i.e., a button) at a user-interface of a program that generated the list of data entries to allow the user to export the data entries to a spreadsheet program. Thus, business data as seen on a computer screen may be dynamically exported to a spreadsheet application. In some embodiments, the user may select an option at the spreadsheet program to refresh the spreadsheet data with updated data, and/or an option to up-load the spreadsheet data back into the data set that was the source of the data entries. The selected data entries may be said to be integrated into the spreadsheet in that the relationship between the data entries and spreadsheet data may be maintained by uploading and/or refreshing the data. In some embodiments, the user may predefine templates that may be used to layout the spreadsheet. It will be appreciated that modifications and variations of the examples described are covered by the teachings provided below and are within the purview of the appended claims.

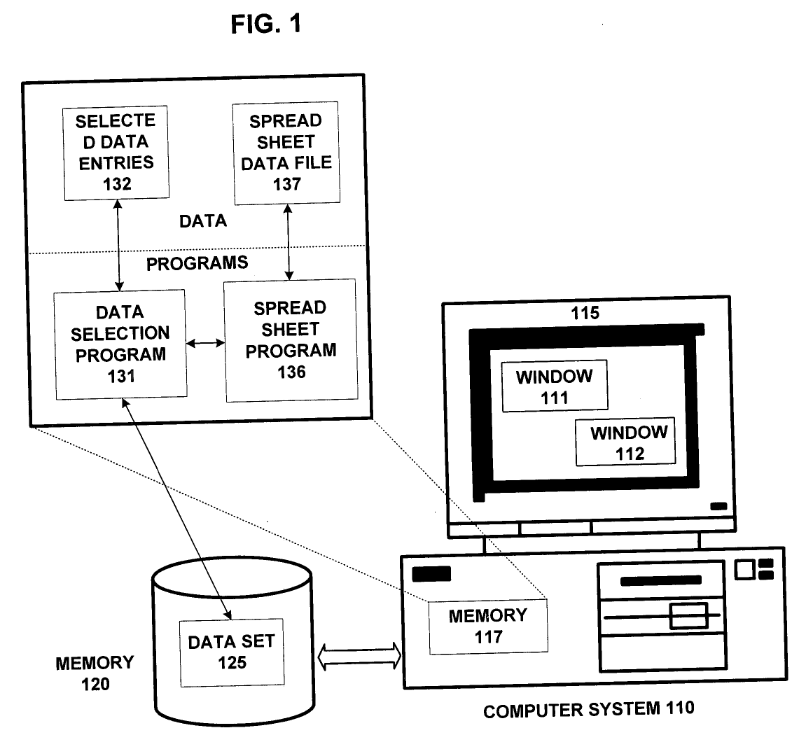

FIG. 1 is a simplified block diagram that illustrates a computer system in which a group of selected data entries may be integrated into a spreadsheet program according to an embodiment of the present invention. FIG. 1 shows a computer system 110 that contains a display 115 and memory 117. Computer system 110 may be, for example, a personal computer system, and memory 117 may be a random access memory (RAM). In some embodiments, memory 117 is a machine readable medium which may store data and computer program(s) comprising a plurality of instructions that are executable by a computer system, such as computer system 110. A machine readable medium is any medium cable of being read by a machine, such as a RAM, floppy disk memory, CD-ROM, etc.

As shown in FIG. 1, computer system 110 is coupled to a memory 120, which may be a disk-drive memory or other type of memory device. In the embodiment shown, memory 120 stores a data set 125, which may be for example a database of information. Data set 125 may contain a plurality of data entries. Data set 125 may contain the data objects stored by a CRM system running on computer system 110, the data for a human resources (HR) system running on computer system 110, and/or the data for any other types of business management systems, as well as data for any other types of systems or programs.

As shown in FIG. 1, memory 117 stores a data selection program 131, spreadsheet program 136, selected data entries 132, and spreadsheet data file 137. Display 115 is shown as displaying a window 111, which may be the user-interface for data selection program 131, and a window 112, which may be the user-interface for spreadsheet program 136. In other embodiments, computer system 110 may be coupled to another computer system over a network, with one computer system (which may be referred to as a “back-end system”) executing the data selection program and the other computer system (which may be referred to as a front-end system) executing the spreadsheet program. In such embodiments, the back-end system may be a terminal server, mainframe computer, or another type of computer system.

Data selection program 131 may be any type of program that retrieves a list of data from data set 125. For example, data selection program 131 may perform a search of data set 125 based on a query. A user may select a list or group of data entries from data set 125 by inputting a request into window 111. For example, assuming that data set 125 contains a plurality of customer data objects, then a user may type into window 111 a request for a list of records for customers having a certain name, and in response data selection program 131 may retrieve these records from data set 125 and write the results into memory 117 as selected data entries 132. As discussed below, the selected data entries may be exported into spreadsheet program 136 as a spreadsheet data file 137.

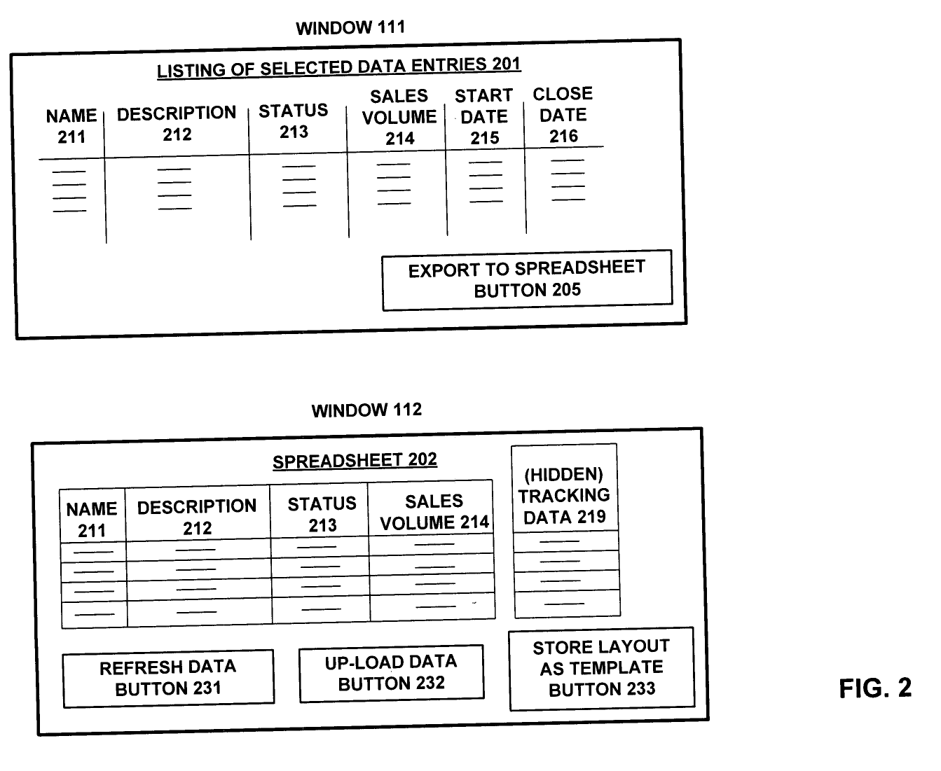

FIG. 2 is a simplified block diagram that illustrates a user-interface for a program that selects a list of data entries and a user-interface for a spreadsheet program according to an embodiment of the present invention. FIG. 2 shows a window 111 and window 112 which may be the user-interface windows on display 115 of computer system 110. As discussed above, window 111 may be a user-interface window for data selection program 131 and window 112 may be a user-interface window for spreadsheet program 136. In FIG. 2, window 111 shows a listing of selected data entries 201 which may contain all or part of a list that meet the criteria specified by a user's request. Listing of selected data entries 201 contains a plurality of columns (211-216) and a plurality of rows. As shown, each column represents a different record that meets the user's search criteria, and each row represents a different field of a record. For example, listing of selected data entries 201 may contain a list of all customers of a particular salesperson, with each item containing information on the description of the customer, the status of the customer, etc. Of course, all of the items on the list (i.e., rows) may not fit into window 111, and the user may be able to scroll up or down through the list within window 111. Window 111 in FIG. 2 also shows an export to spreadsheet button 205 that may be chosen by a user to export selected data entries 132 into spreadsheet program 137, as discussed below.

Window 112 in FIG. 2 shows a spreadsheet 202, which may contain data exported from the selected data entries. As shown, spreadsheet 202 contains a plurality of values arranged in a plurality of columns (211-214) and a plurality of rows. In the example shown, spreadsheet 202 contains a subset of the columns in listing of selected data 201 (i.e., name, description, status and sales volume). In some embodiments, information such as the number of rows, header descriptions, and field types are also exported. In this example, columns may have been deleted from the spreadsheet by the user of the spreadsheet or, as discussed below, the columns may have been deleted according to a predefined template when exporting the data entries to the spreadsheet. As shown in window 112, spreadsheet 202 also contains tracking data 219. As also discussed below, tracking data 219 may store meta-data that is used to track or map data values in spreadsheet 112 back to corresponding data entries in data set 125. In some embodiments, tracking data 219 may be part of spreadsheet data file 137 but may be hidden from users of spreadsheet 202, in which case tracking data 219 would generally not appear in window 112 (although it may be displayed at certain times, such as during debug).

Window 112 in FIG. 2 also shows refresh data button 231, up-load data button 232, and store layout as template button 233. In embodiments, when a user selects refresh data button 231, any data values in spreadsheet 202 will be modified to reflect the value currently stored in the corresponding entry in data set 125, to the extent spreadsheet 202 does not already reflect the current value in data set 125. For example, if the value of the corresponding entry in data set 125 has been modified since the data entries were imported into spreadsheet 202, or if the data in spreadsheet 202 has been changed, the spreadsheet will be updated to reflect the value currently in data set 125. In some embodiments, when a user selects up-load data button 232, data values in spreadsheet 202 will be written back to the corresponding entries in data set 125. In some embodiments, the store layout as template button 233 may be selected by a user to store the current spreadsheet layout as a template for a future spreadsheet. For example, a user may wish to store the current layout of spreadsheet 202 (i.e., the layout of the columns name 211, description 232, status 213, and sales volume 214) so that if at a later time a user exports another list (such as listing of selected data 201) from the user-interface for data selection program 131 into the spreadsheet, the data may be automatically conformed to the layout shown in window 112 of FIG. 2. Of course, in other embodiments, other functionality may be used instead of a buttons 205 and 231-233, such as a checkbox, pull-down menu, etc.

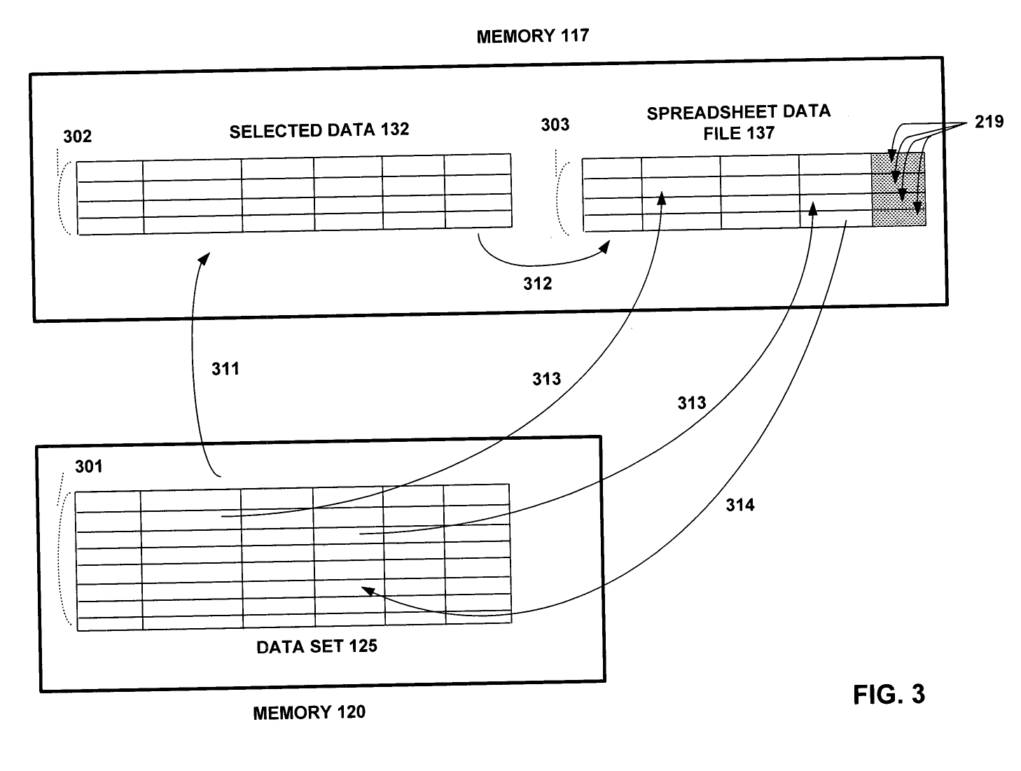

FIG. 3 is a simplified block diagram that illustrates the integration between entries in a data set and a spreadsheet data file according to an embodiment of the present invention. FIG. 3 shows memory 120 containing data set 125, and FIG. 3 shows memory 117 containing selected data entries 132 and spreadsheet data file 137. Data set 125 is shown as a plurality of entries 301, selected data entries 132 are shown as a plurality of entries 302, and spreadsheet data file 137 is shown as plurality of entries 303. As shown in FIG. 3, spreadsheet data file 137 contains a plurality of hidden data fields 219 that contain meta-data that map entries in spreadsheet data file 137 back to entries in data set 125. As discussed further below, FIG. 3 shows the selection of data entries from data set 125 (as represented by arrow 311), the formatting of selected data entries 132 into a spreadsheet data format (as represented by arrow 312), the refreshing of entries in spreadsheet data file 137 based on entries in data set 125 (as represented by arrows 313), and the uploading of an entry from spreadsheet data file 137 back into data set 125 (as represented by arrow 314). Of course, in other embodiments data set 125 may be contained in the same memory as selected data entries, and spreadsheet data file 137 may be stored in a different memory than selected data entries 132.

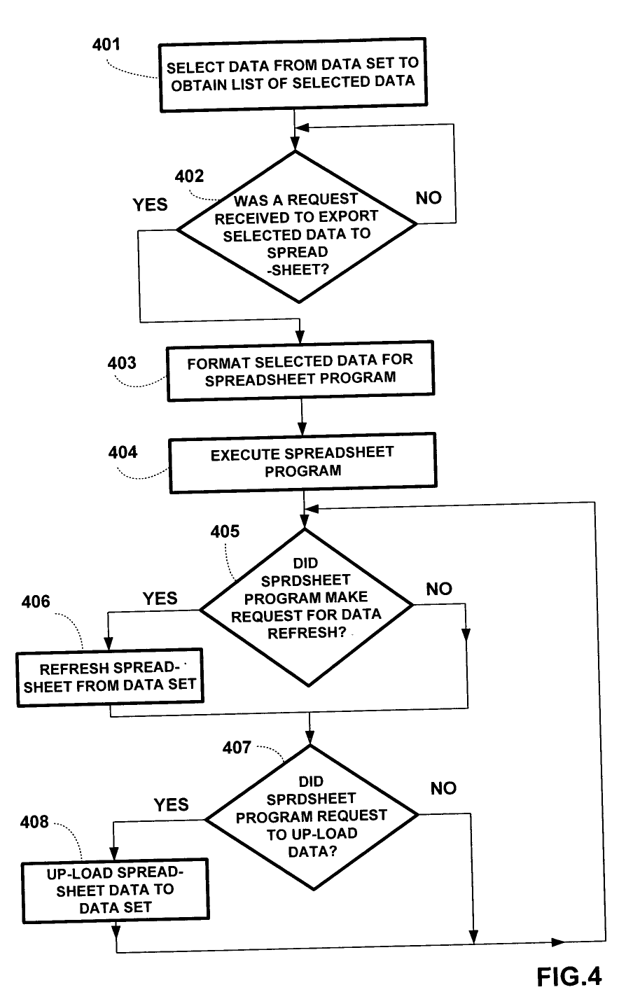

FIG. 4 is a simplified flow diagram that illustrates a method of integrating a group of data entries into a spreadsheet program according to an embodiment of the present invention. For the purposes of illustration, this method will be discussed with the systems shown in FIGS. 1-3, but of course this method may be practiced with other systems. Based on criteria that may be specified from a user, the system initially selects data entries from a data set to obtain a list or group of selected data entries (401). For example, a user may type a request into window 111 that causes data selection program 131 to obtain selected data entries 132. This group of selected data entries may be stored in memory 117 and displayed as a list in window 111 (as shown in FIG. 2). If a request was received to export the selected data entries from the data selection program to a spreadsheet (402), for example as detected by button 205 in data selection program 131, then the selected data entries will be formatted into a spreadsheet data file that is in a format recognized by a spreadsheet program (403) and a spreadsheet program will be executed with the spreadsheet data file (404). For example, data selection program 131 may create spreadsheet data file 137 and may invoke spreadsheet program 136 with this spreadsheet data file. For example, the spreadsheet program may be launched if currently not executing or, if it is currently executing, the spreadsheet program may be brought-up as a current task. In some embodiments, the creating of spreadsheet data file may include the creation of hidden fields that map entries in the spreadsheet back to entries in the data set.

At a later time, the spreadsheet program may make a request for refreshed data, for example if the user selects refresh data button 231. If such a request was made (405), then the spreadsheet data file may be refreshed with current data values from data set 125. For example, if the value of entry in data set 125 is no longer the same as the value of a corresponding entry in spreadsheet data file 137 (i.e., if either one has been changed), then as shown by arrows 313 in FIG. 3, the value in data set 125 may be written into the corresponding entry in spreadsheet data file 137 (406). In some embodiments, meta-data in hidden fields 219 may be used to determine if entries in spreadsheet data file 137 have been changed. Similarly, at a later time, the spreadsheet program may make request to up-load data, for example if the user selects upload data button 232. If such a request was made (407), then all or part of the spreadsheet data file may be up-loaded back to the corresponding entries in data set 125 (408). For example, if the value of an entry in spreadsheet data file 137 has been changed, then as shown by arrow 314 in FIG. 3, this value may be written back to the corresponding entry in data set 125. In some embodiments, meta-data in hidden fields 219 may be used to determine if entries in spreadsheet data file 137 have been changed. In other embodiments, all of the values in spreadsheet data file 137 are written back, regardless of whether they have been changed. In embodiments, as the spreadsheet program continues to execute, it may monitor for further requests to refresh data or up-load data.

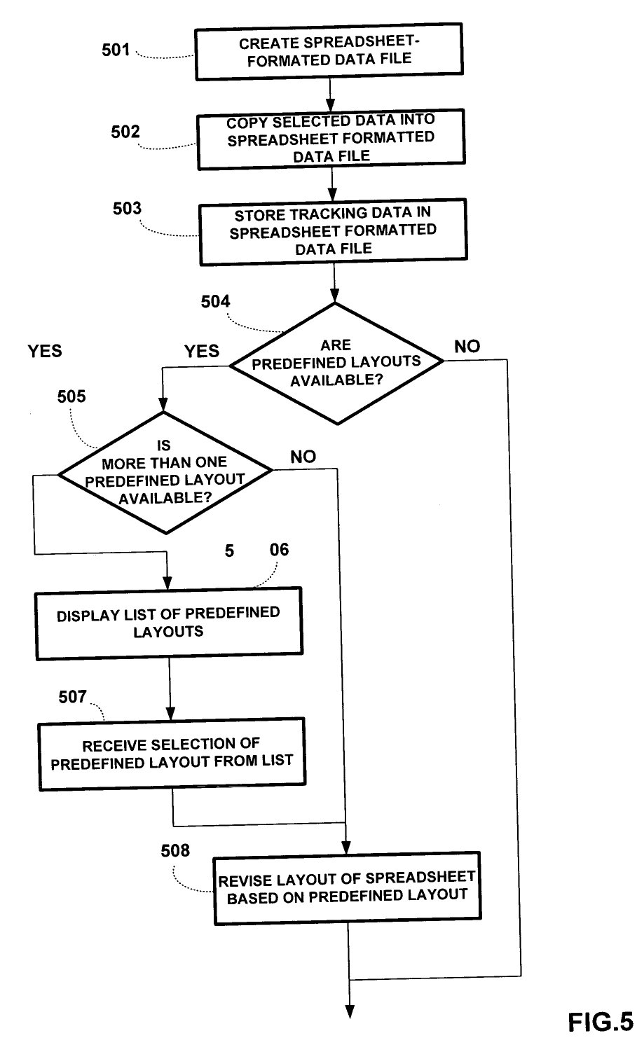

FIG. 5 is a simplified flow diagram that illustrates a method of creating a spreadsheet-formatted data file based on a group of data entries according to an embodiment of the present invention. This method may be performed after a request was received to export selected data entries to a spreadsheet. A data file that contains the formatting recognized by the spreadsheet program (e.g., an .XLS file recognized by the Excel® spreadsheet) may be created (501). This spreadsheet data file may be configured to have columns to accommodate fields in the selected data entries. Selected data entries may be copied into the spreadsheet formatted data file (502). Next, it may be determined whether a predefined spreadsheet layout is available (503). Such layouts may be have been saved by a user at an earlier time. If such a layout is not available, a default layout may be used, in which case the spreadsheet may contain as many columns as the selected data entries. If a predefined layout is available, then it may be determined whether more than one layout is available (504) and, if so, a group of layouts may be displayed (505) so that the user may select a particular layout (506). In some embodiments, the templates may be displayed as icons (such as for an update pricing, supplier comparison, or pricing analysis spreadsheet) and the user may be able to view a preview of the layout before it is selected. The spreadsheet may then be revised to conform to the (selected) predefined layout (507). For example, columns may be removed from selected data entries (e.g., columns 215 and 216 and FIG. 2), the placement of columns may be moved, or a graphic (such as a picture or chart) may be included in the spreadsheet.

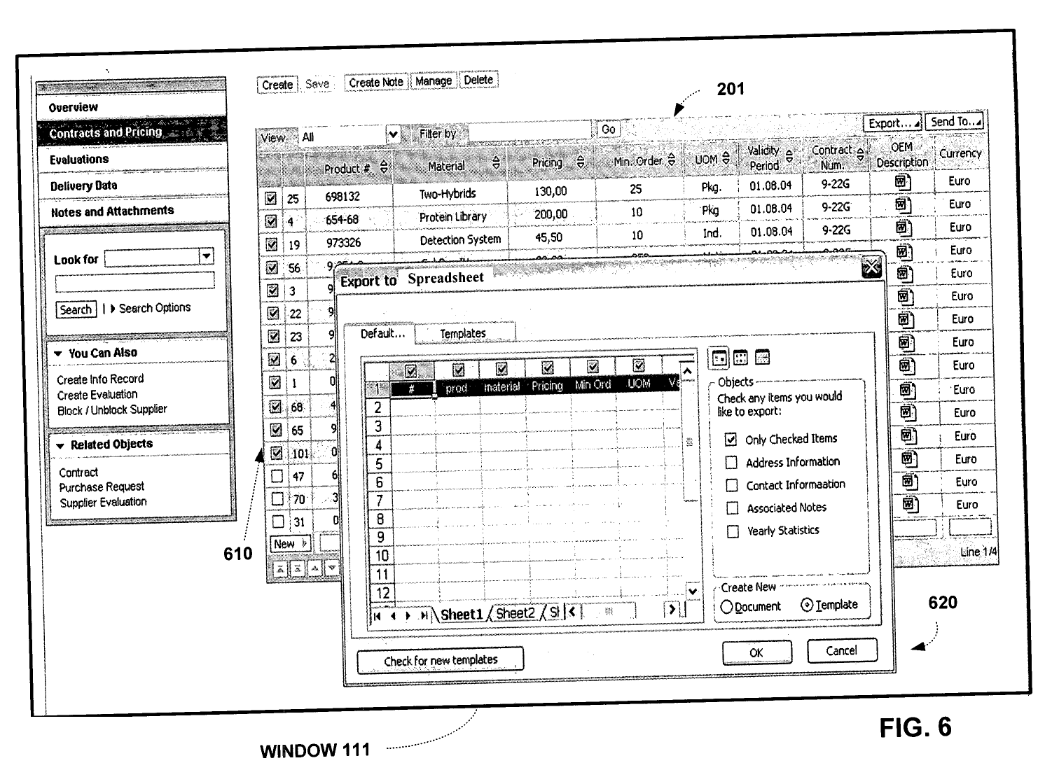

FIG. 6 is a simplified block diagram that illustrates a more detailed view of a user-interface for a program that selects a group of data entries according to an embodiment of the present invention. FIG. 6 shows window 111 of FIGS. 1-2, including an example list of selected data entries 201. As shown in FIG. 6, the list view contains check-boxes (610) that allows the user to select which entries they want to export to the spreadsheet. FIG. 6 also contains a spreadsheet preview 620 that shows the user the appearance of the spreadsheet to be created. As shown in FIG. 6, the user may be able to select a template or modify the layout of the spreadsheet by selecting (e.g., using checkboxes) particular columns to be exported. In the embodiment shown, the user may use preview 620 to create a new spreadsheet document or to create a new spreadsheet template. Thus, an interface is provided that may be used to selectively choose business data and associated information that is to be exported to a spreadsheet application. In some embodiments, data retrieved from the system may be left out or additional, predefined, associated business information can be included in the export. In some embodiments, initial selection of business objects, filtering, searching for exportable data, complex searching, and unrestricted browsing of business object information in the data set would be handled by a back-end system, rather than through the spreadsheet program.

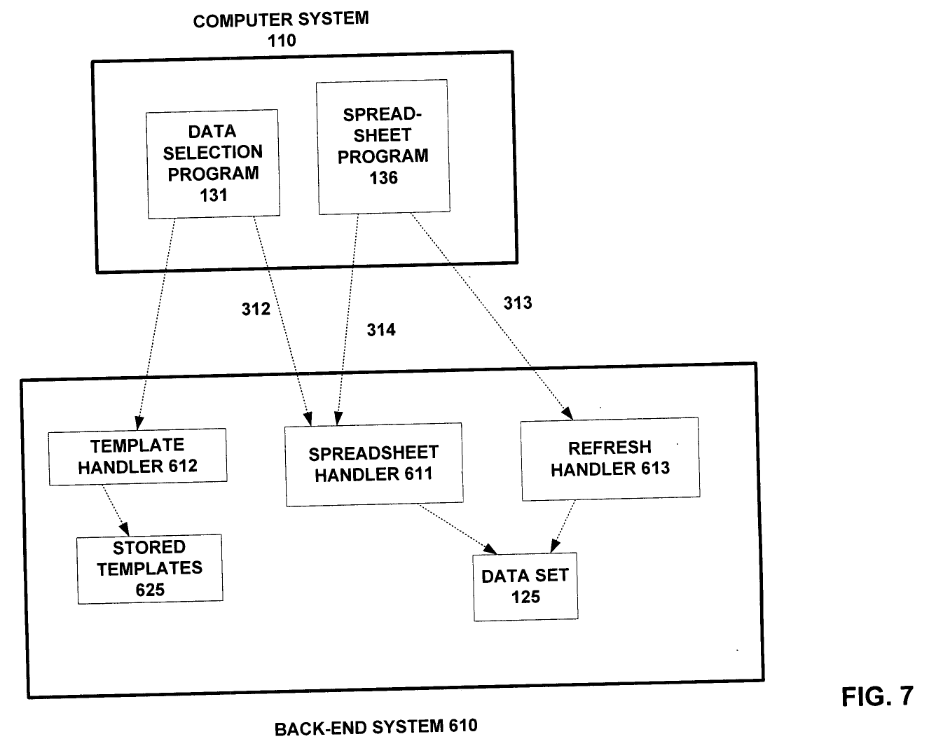

FIG. 7 is a simplified block diagram that illustrates program control flow for the integration of selected data entries into a spreadsheet according to an embodiment of the present invention. FIG. 7 shows computer system 110 with data selection program 131 and spreadsheet program 136. FIG. 7 also shows back-end system 610 with instructions for a spreadsheet handler 611, template handler 612, and refresh handler 613, as well as a data file for stored templates 625 and data set 125. In the embodiment shown, the spreadsheet integration is implemented as a function of the back-end system. In the embodiment shown, when data selection program 131 receives a request to expert data entries to a spreadsheet, it may call or send a message to the template handler 612 in the back-end system, as shown by arrow 314, for example using Web services or some other communications functionality. In some embodiments, such a call may be made as a Remote Function Call (RFC), Simple Object Access Protocol/http, or by using some other protocol. The call may be differentiated in different parameter variants such as an indication of the query and the criteria used (filter, columns, query name, etc.), which may allow from mapping back from spreadsheet data entries to the data set. In other embodiments, a schema describing the structure of the selected data entries may be passed in the call along with an associated Extensible Markup Language (.XML) file. The call may also indicate if the spreadsheet is to be provided on the basis of a template.

In some embodiments, the spreadsheet handler may generate the spreadsheet data file by generating a file that describes the describes the structure of the spreadsheet (e.g., columns) and as second file with a mapping of the data entries in the spreadsheet from the data set, and these files may be combined to create the spreadsheet data file. An XML Schema Definition (XSD) file may be used to describe and validate the data. In some embodiments, the XSD file may be passed to the back-end system or may be created by the back-end system based upon the structure of the query. The data responsive to the query may then be provided in an .XML structure or may be produced in some other fashion. A special style sheet may be transferred together with the XSD schema (with the structure of the list) based on an Extensible Style Language (XSL) transformation for the spreadsheet in a further stylesheet (i.e., a list-specific stylesheet). During this transformation, the structure of the Spreadsheet may be specified and the XSD schema inserted into the result. The Stylesheet may be transformed together with the data values by a further XSL transformation to create the final spreadsheet data file (e.g., in the .XLS format).

As shown in FIG. 7, the spreadsheet program may call the refresh handler 613 to refresh data in the spreadsheet (313) and may call the spreadsheet handler 611 to upload data from the spreadsheet back into the data set 125 (314). In addition, when a request to export data entries to a spreadsheet is received, the data selection program 131 may call template handler 612 to select one of the stored templates 615 as discussed above with reference to FIG. 5. In embodiments, a single Dynamic Link Library (DLL) file is used to provide communication with the backend system. Metadata (such as query, template name, and spreadsheet customizing) may be stored as an expansion back on a central server and may be linked to the instance of the spreadsheet program. A refresh command from the spreadsheet program may initiate a query at the back-end system which includes parameters (e.g., query name, selected values, etc.). XML data for the refreshed may be sent to the front-end system and merged or pasted into the spreadsheet data file. During an upload, XML content may be posted to the back-end system. In some embodiments, the XML file indicates the original of the data. For example, each line may have a key that represents an object in the data set (database) and values for each field. The XML content may be parsed, the data synchronized, and the data operations validated. If there are warnings or errors, a protocol may be returned back to the user, for example via an email. During an upload operation, the data may be read row by row and compared with the uploaded data, and updates may be made if necessary.

The above is a detailed discussion of certain embodiments. It may be understood that the examples discussed are for illustration purposes only and are not intended to limit the configuration to that shown. For example, the order of the steps performed may be varied as appropriate. It is of course intended that the scope of the claims may cover other embodiments than those described above and their equivalents.

What is claimed is:

1. A method comprising:
selecting data entries from a data set stored on a computer system using a first computer program to obtain a group of selected data entries;
determining that a user of the first computer program has made a request to export the group of selected data entries from the first computer program to a spreadsheet program;
performing the following in response to the request to export:
formatting the group of selected data entries into a spreadsheet data file that is in a format recognized by the spreadsheet program;
causing the spreadsheet program to execute with the spreadsheet data file;
determining that a request was received at the spreadsheet program for refreshed data; and
in response to the request for refreshed data, writing a current data value for at least one entry in the data set into a corresponding entry in the spreadsheet data file.

2. The method of claim 1, wherein the method further comprises:
determining that a request was received from the spreadsheet program requesting an upload of data from the spreadsheet data file back into the data set that is stored on the computer system; and
writing a data value from an entry in the spreadsheet data file into a corresponding entry in the data set stored on the computer system.

3. The method of claim 1, wherein formatting the group of selected data into a format recognized by the spreadsheet program comprises:
determining whether the user has pre-defined a template for a spreadsheet layout; and
if the user has a pre-defined template for formatting data, creating a spreadsheet data file that is based on the layout specified by the pre-defined template.

4. The method of claim 3, wherein creating the spreadsheet data file comprises importing a graphic element into the spreadsheet data file based upon the predefined template.

5. The method of claim 3, wherein the pre-defined template was created by the user selecting an option in the spreadsheet program to save the layout of an opened spreadsheet as a pre-defined template.

6. The method of claim 2, wherein the spreadsheet data file comprises hidden fields that contain tracking information for data entries in the spreadsheet data file.

7. The method of claim 6, wherein the data entries are selected based on a query from the user, and wherein the tracking information comprises the query.

8. The method of claim 6, wherein the entry in the spreadsheet data file corresponding to the entry in the data set is identified based on the tracking information.

9. The method of claim 6, wherein the method further comprises:
determining that a request was received from the spreadsheet program requesting an upload of data from the spreadsheet data file back into the data set that is stored on the computer system; and
writing a data value from an entry in the spreadsheet data file into a corresponding entry in the data set stored on the computer system, wherein the entry in the data set corresponding to the entry in the spreadsheet data file is identified based on the tracking information.

10. The method of claim 1, wherein the first program is one of a customer relationship management program or a human resources program.

11. A machine-readable medium storing a set of instructions, the set of instructions capable of being executed by a processor to implement a method in a computer system comprising:
selecting data entries from a data set stored on a computer system using a first computer program to obtain a group of selected data entries;
determining that a user of the first computer program has made a request to export the group of selected data entries from the first computer program to a spreadsheet program;
performing the following in response to the request to export:
formatting the group of selected data entries into a spreadsheet data file that is in a format recognized by the spreadsheet program;
causing the spreadsheet program to execute with the spreadsheet data file;
determining that a request was received at the spreadsheet program for refreshed data; and
in response to the request for refreshed data, writing a current data value for at least one entry in the data set into a corresponding entry in the spreadsheet data file.

12. The machine-readable medium of claim 11, wherein the method further comprises:
determining that a request was received from the spreadsheet program requesting an upload of data from the spreadsheet data file back into the data set that is stored on the computer system; and
writing a data value from an entry in the spreadsheet data file into a corresponding entry in the data set stored on the computer system.

13. The machine-readable medium of claim 11, wherein formatting the group of selected data into a format recognized by the spreadsheet program comprises:
determining whether the user has pre-defined a template for a spreadsheet layout; and
if the user has a pre-defined template for formatting data, creating a spreadsheet data file that is based on the layout specified by the pre-defined template.

14. The machine-readable medium of claim 13, wherein creating the spreadsheet data file comprises importing a graphic element into the spreadsheet data file based upon the predefined template.

15. The machine-readable medium of claim 13, wherein the pre-defined template was created by the user selecting an option in the spreadsheet program to save the layout of an opened spreadsheet as a pre-defined template.

16. The machine-readable medium of claim 12, wherein the spreadsheet data file comprises hidden fields that contain tracking information for data entries in the spreadsheet data file.

17. The machine-readable medium of claim 16, wherein the data entries are selected based on a query from the user, and wherein the tracking information comprises the query.

18. The machine-readable medium of claim 16, wherein the entry in the spreadsheet data file corresponding to the entry in the data set is identified based on the tracking information.

19. The machine-readable medium of claim 16, wherein the method further comprises:
determining that a request was received from the spreadsheet program requesting an upload of data from the spreadsheet data file back into the data set that is stored on the computer system; and
writing a data value from an entry in the spreadsheet data file into a corresponding entry in the data set stored on the computer system, wherein the entry in the data set corresponding to the entry in the spreadsheet data file is identified based on the tracking information.

20. The machine-readable medium of claim 11, wherein the first program is one of a customer relationship management program or a human resources program.
